(19) United States
(12) Patent Application Publication
(10) Pub. No.: US 2026/0038937 A1
(43) Pub. Date: Feb. 5, 2026

(54) BATTERY PACK REPLACEMENT SYSTEM

(71) Applicant: TOYOTA JIDOSHA KABUSHIKI KAISHA, Toyota-shi (JP)

(72) Inventors: Takenori MIKAMI, Miyoshi-shi (JP); Kenji BABA, Seto-shi (JP)

(73) Assignee: TOYOTA JIDOSHA KABUSHIKI KAISHA, Toyota-shi (JP)

(21) Appl. No.: 19/265,768

(22) Filed: Jul. 10, 2025

(30) Foreign Application Priority Data
Aug. 1, 2024 (JP) 2024-126068

(51) Int. Cl. H01M 50/244; H01M 50/204; H01M 50/258

(52) U.S. Cl. CPC H01M 50/244; H01M 50/204; H01M 50/258

(57) ABSTRACT

To provide a battery pack replacement system adapted to enable easy replacement of battery packs that are densely-arranged inside a case. A battery pack replacement system includes: a battery unit including a battery pack and a pipe, a direction along one side of a bottom of the battery pack being a conveyance direction of the battery unit and the pipe being fixed along a lower surface or a side surface of the battery pack; a case for stacking and housing the battery unit therein; and a rod member that is configured to be inserted into the pipe along the conveyance direction of the battery unit and has a movable part configured to be elevatable in a stacking direction of the battery unit.

### CROSS REFERENCE TO RELATED APPLICATIONS

This application is based upon and claims the benefit of priority from Japanese patent application No. 2024-126068, filed on Aug. 1, 2024, the disclosure of which is incorporated herein in its entirety by reference.

### BACKGROUND

The present disclosure relates to a battery pack replacement system. There is a storage battery system in which a plurality of battery packs are stacked and housed in a case. As the durability of the storage battery system is improved, the weight of a battery pack becomes heavy. In performing the maintenance of a battery pack, should a battery pack be heavy when a battery pack is taken out of a case or a new battery pack is loaded into a case, the replaceability of the battery is poor. To address this problem, Patent Literature 1 discloses a method for moving a battery pack by sliding using a roller installed in the battery pack.

[Patent Literature 1] Japanese Unexamined Patent Application Publication No. 2013-038002

### SUMMARY

As the size of a storage battery system reduces while the number of the battery packs loaded in the system increases, the battery packs need to be densely-arranged inside a case. In this case, the replaceability of the battery packs may deteriorate.

The present disclosure has been made to solve such a problem, and provides a battery pack replacement system adapted to enable easy replacement of battery packs that are densely-arranged inside a case.

A battery pack replacement system according to the present disclosure includes:
a battery unit including a battery pack and a pipe, a direction along one side of a bottom of the battery pack being a conveyance direction of the battery unit and the pipe being fixed along a lower surface or a side surface of the battery pack;
a case for stacking and housing the battery unit therein; and
a rod member that is configured to be inserted into the pipe along the conveyance direction of the battery unit and has a movable part configured to be elevatable in a stacking direction of the battery unit, wherein
the battery unit is conveyed to the case along the conveyance direction of the battery unit, and is housed in the case by placing the pipe on an upper surface of a protruding part protruding inward from an inner wall of a side surface of the case,
the pipe includes holes that are formed in the surface thereof to be placed on the protruding part,
the rod member inserted into the pipe is configured to:
   have the movable part protrude from inside the pipe through the holes to thereby bring the pipe and the protruding part to a state of being spaced apart from each other; and
   house the movable part into the pipe to thereby place the pipe on the protruding part.

By this configuration, battery packs that are densely-arranged inside a case can be easily replaced.

The battery pack replacement system in which the battery unit is conveyed into or out of the case by pushing or pulling the battery unit in the conveyance direction thereof under a state in which the pipe and the protruding part are spaced apart from each other, the movable part being configured to protrude from the pipe via the holes.

The movable part may be a roller.

The movable part may be configured to be elevatable by pneumatic-driving.

A cross-sectional outer profile of the pipe may be rectangular.

According to the present disclosure, it is possible to provide a battery pack replacement system adapted to enable easy replacement of battery packs that are densely-arranged inside a case.

The above and other objects, features and advantages of the present disclosure will become more fully understood from the detailed description given hereinbelow and the accompanying drawings.

### BRIEF DESCRIPTION OF DRAWINGS

FIG. 1 is a diagram showing a battery unit housed in a case according to a first embodiment;

FIG. 2 is an explanatory view of the battery pack replacement system according to the first embodiment;

FIG. 3 is an explanatory view of a rod member according to the first embodiment;

FIG. 4 is a diagram showing the battery pack replacement system when the movable part thereof is in an elevated state or a lowered state;

FIG. 5 is a flowchart of a battery pack replacement method according to the first embodiment; and

FIG. 6 is a diagram showing a state of replacing a battery pack according to the first embodiment.

### DESCRIPTION OF EMBODIMENTS

### First Embodiment

A battery pack replacement system according to a first embodiment will be described below with reference to the drawings.

### Configuration of Battery Pack Replacement System

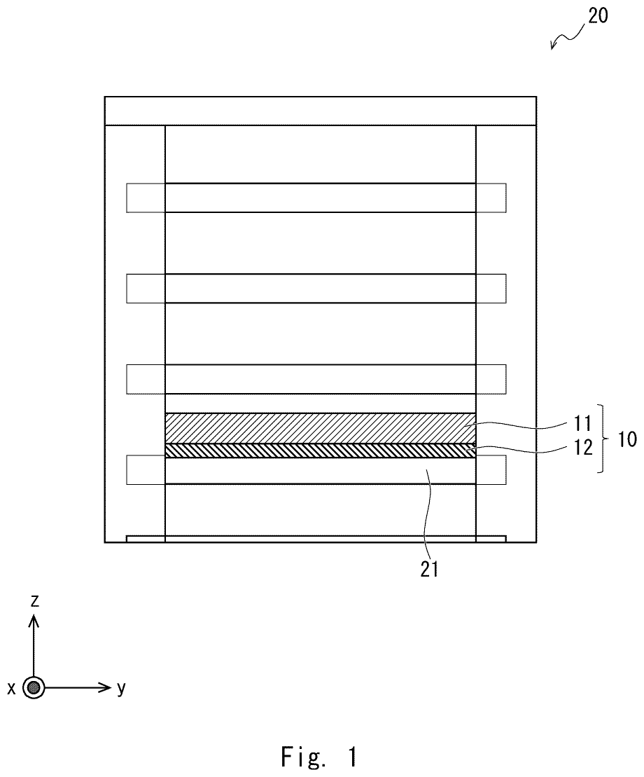

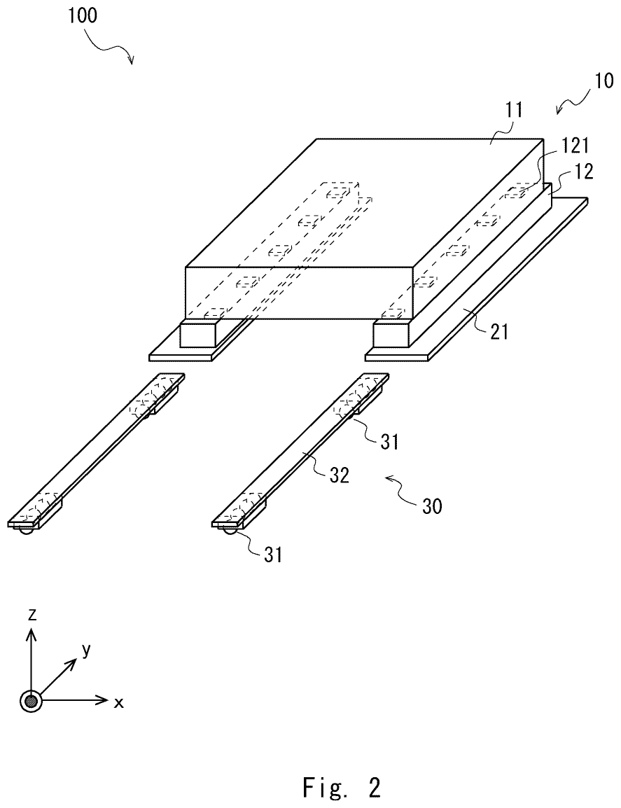

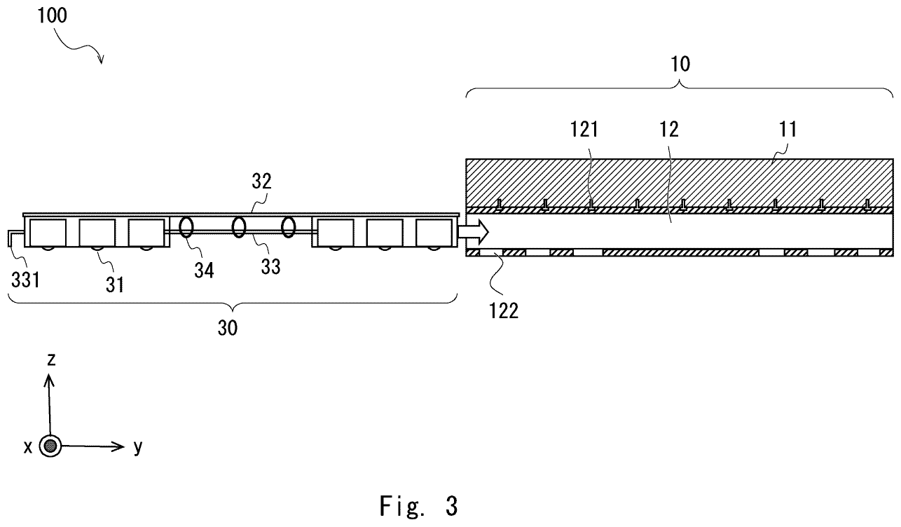

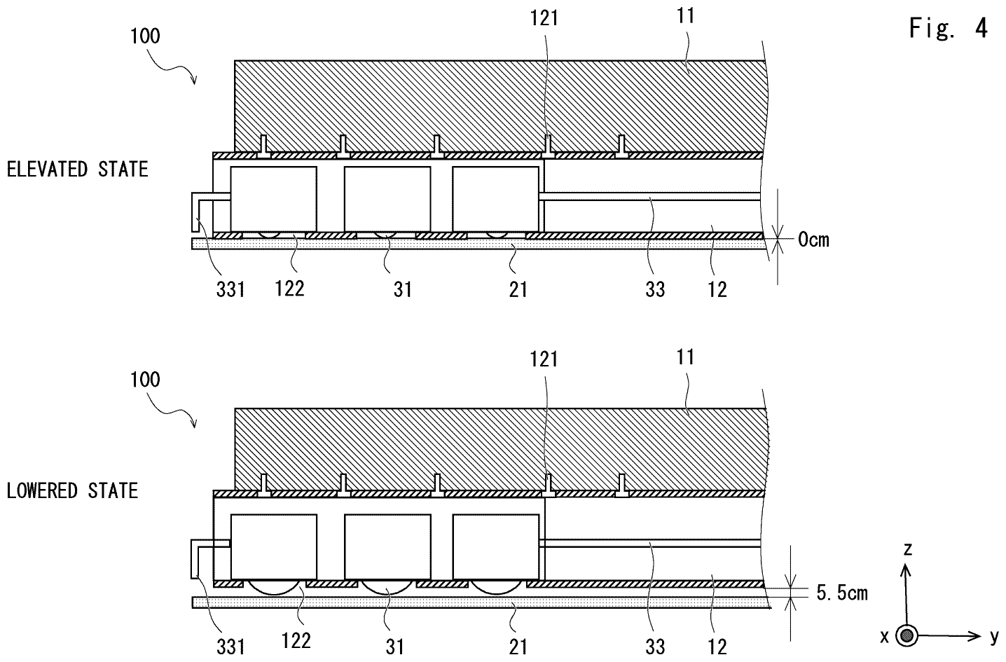

First, a configuration of a battery pack replacement system according to the first embodiment will be described with reference to FIGS. 1 to 4. FIG. 1 is a diagram showing a battery unit housed in a case according to the first embodiment. FIG. 2 is an explanatory view of the battery pack replacement system according to the first embodiment. FIG. 3 is an explanatory view of a rod member according to the first embodiment. FIG. 4 is a diagram showing the battery pack replacement system when the movable parts thereof are in an elevated state or a lowered state.

As shown in FIGS. 1 and 2, a battery pack replacement system 100 includes a battery unit 10, a case 20, and a rod member 30.

The battery unit 10 includes a battery pack 11 and a pipe 12. The battery pack 11 is formed in a substantially rectangular parallelepiped shape. The number of the battery packs 11 in one battery unit 10 is not limited to one, and a plurality of battery packs 11 may be arranged inside one battery unit 10. The battery pack 11 includes, in its interior, members and electrodes constituting a secondary battery (not shown). In the first embodiment, the secondary battery in the battery pack 11 is not particularly limited. For example, the battery pack 11 may include various secondary batteries such as lithium-ion batteries, nickel-metal hydride batteries, and lead-acid batteries.

In the following description, an xyz three-dimensional orthogonal coordinate system will be used as appropriate. The x, y, and z-axis directions are parallel to each side of the rectangular parallelepiped battery pack 11. Here, the direction in which the battery unit 10 is conveyed into the case 20 (i.e., the conveyance direction) is the direction along one side of the bottom of the battery pack 11. In the first embodiment, the y-axis direction is assumed to be the conveyance direction of the battery unit 10. In the following description, the z-axis direction is assumed to be vertical direction, and the xy plane is assumed to be a horizontal plane. Of course, the z-axis direction may be inclined from the vertical direction, and the xy plane may be inclined from the horizontal plane.

The pipe 12 is fixed along the lower surface or the side surface of the battery pack 11 by fastening with at least one bolt 121. The fixing method is not particularly limited. For example, the fixing method may be welding or chemical bonding, and the pipe 12 is formed with the longitudinal direction thereof being the conveyance direction (the y-axis direction). The shape of a cross-sectional outer profile of the pipe 12 is not particularly limited. In the first embodiment, the cross-sectional outer profile of the pipe 12 is rectangular. Since the cross-sectional outer profile of the pipe 12 is rectangular, the installation of the battery pack 11 in the case 20 is stabilized. The cross-sectional outer profile of the pipe 12 is not limited to a rectangular shape, but may be circular or triangular.

The number of the pipes 12 disposed in one battery unit 10 is not limited to one, and a plurality of pipes 12 may be disposed. In the first embodiment, one battery unit 10 includes two pipes 12. Here, the pipes 12 are provided at both ends of the battery pack 11 in the x-axis direction. The pipe 12 has a hollow portion. The rod member 30 is inserted into the hollow portion of the pipe 12 in the conveyance direction (the y-axis direction). The pipe 12 has at least one hole 122 on the lower surface (surface on the z-axis negative side) thereof.

The case 20 is for stacking and housing at least one battery unit 10 therein. In the first embodiment, the stacking direction of the battery unit 10 is the z-axis direction. The case 20 is provided with a protruding part 21 protruding inward from the inner wall of the side surface of the case 20. The protruding part 21 is provided on one of the side surfaces of the case 20 and a side surface facing the one of the side surfaces, respectively. The protruding part 21 is a plate-like member for supporting both ends of the battery unit 10. The side surface of the case 20 where the protruding part 21 is provided is parallel to the yz plane. The side surface of the case 20 parallel to the xz plane has an opening for taking the battery unit 10 in and out.

As shown in FIG. 2, the pipe 12 provided in the battery unit 10 is placed on the upper surface (the z-axis positive direction side) of the protruding part 21, through which the battery unit 10 is conveyed to the case 20 and housed therein. The case 20 may have a shelflike shape in which the protruding part 21 is provided in a plurality of stages in the stacking direction (the z-axis direction). In the shelflike-shaped case 20, the pipes 12 of the battery unit 10 are disposed on the protruding part 21 provided in each stage, whereby a plurality of the battery units 10 can be stacked and housed in the case 20. Further, the housed battery unit 10 may be fixed to the case 20 by fastening the pipes 12 and the protruding part 21 with bolts, rivet, or the like.

The rod member 30 is used to convey the battery unit 10 into or out of the case 20 when replacing the battery unit 10 in the case 20. The rod member 30 may serve as a part of the case 20 by being attached to the door or the reinforcing frame of the case 20 except when replacing the battery unit 10. As shown in FIG. 3, the rod member 30 includes movable parts 31, a support part 32, and a transmission part 33.

The movable part 31 is a member which is configured to be elevatable in the stacking direction (the z-axis direction). The movable part 31 is elevated in the stacking direction (the z-axis direction) by pneumatic-driving. The driving method is not limited to pneumatic-driving, but may be electric-driving or hydraulic-driving, for example. In the case of pneumatic-driving, the occurrence of damage to the battery pack 11 due to leakage of electricity or oil is suppressed.

In the first embodiment, the movable part 31 is a roller. A roller is attached to the rod member 30 so that the roller moves in the longitudinal direction (the y-axis direction) of the rod member 30. The movable part 31, i.e., the roller, slides on the protruding part 21, whereby the battery unit 10 can be easily conveyed into or out of the case 20. The movable part 31 is not limited to a roller. For example, a material whose coefficient of friction with respect to the protruding part 21 is smaller than the coefficient of friction of the pipe 12 with respect to the protruding part 21 may be employed for the protruding part 21.

A plurality of the movable parts 31 are provided per support part 32. For example, in one support part 32, a plurality of the movable part 31 are arranged side by side in the y-axis direction. The movable part 31 is connected to another movable part 31 through the transmission part 33. The transmission part 33 is provided in the rod member 30 to supply pneumatic pressure, current, and hydraulic pressure to the movable part 31. In the case of pneumatic-driving or hydraulic-driving, a tube is used as the transmission part 33, and in the case of electric-driving, wiring is used as the transmission part 33. The transmission part 33 is connected to a driving source (not shown) via an inlet 331. In order to prevent the transmission part 33 from hanging down, the transmission part 33 is fixed to the support part 32 by a fixing part 34 such as a clamp.

When the battery unit 10 is conveyed out of the case 20, the rod member 30 is inserted into the pipe 12 along the conveyance direction (the y-axis direction) as shown in FIG. 3. After the insertion, the movable part 31 and the holes 122 match each other in their positions in the xy plane. When the movable part 31 is in an elevated state (the z-axis positive direction), the movable part 31 is housed inside the pipe 12. In this case, as shown in FIG. 4, the pipe 12 is placed on the protruding part 21.

On the other hand, when the movable part 31 is in a lowered state (the z-axis negative direction), the movable part 31 protrudes from the inside of the pipe 12 via the holes 122. In this case, as shown in FIG. 4, the battery unit 10 is lifted by the movable part 31, and the pipe 12 and the protruding part 21 are brought to a state of being spaced part from each other. In a state in which the pipe 12 and the protruding part 21 are spaced apart from each other, the battery unit 10 is conveyed into or out of the case 20 by pushing or pulling the battery unit 10 in the conveyance direction (the y-axis direction).

### Method of Replacing Battery Pack

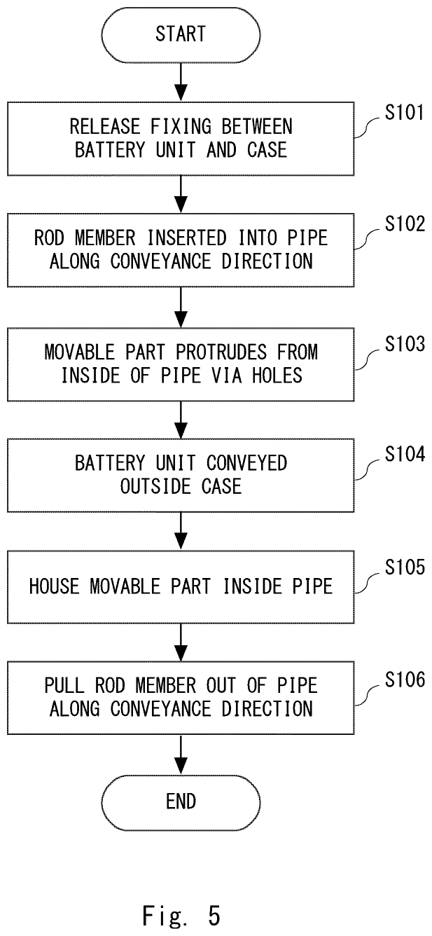

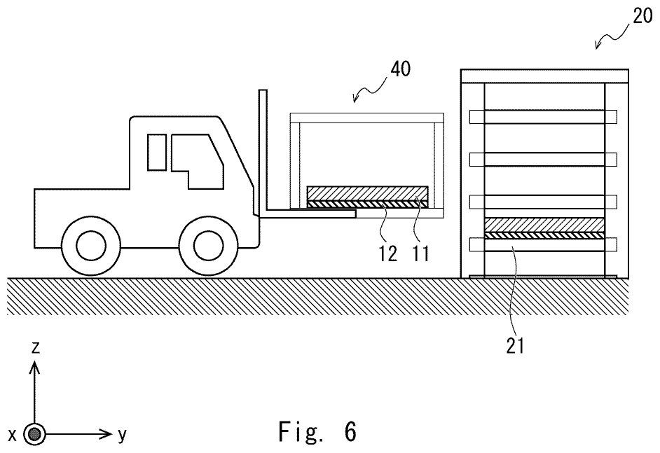

Next, referring to FIGS. 5 and 6, a method of replacing the battery pack 11 by the battery pack replacement system 100 according to the first embodiment will be described. FIG. 5 is a flowchart of the method of replacing battery pack according to the first embodiment. FIG. 6 is a diagram showing the state of replacing battery pack according to the first embodiment.

Here, a method of conveying the battery unit 10 outside the case 20 will be described. To convey the battery unit 10 into the case 20, the method described herein below is carried out in the reverse order.

First, the fixing between the battery unit 10 and the case 20 is released (Step S101). The fixing is released by removing bolts and rivets that bind the pipe 12 and the protruding part 21. In the case where the battery unit 10 and the case 20 are not fixed to each other, Step S101 is not performed.

Next, the rod member 30 is inserted into the pipe 12 along the conveyance direction (the y-axis direction) (Step S102). At the time of insertion, since the movable part 31 is in an elevated state (the z-axis positive direction), it is housed into the pipe 12. The rod member 30 is inserted into the pipe 12 so that the movable part 31 and the holes 122 match each other in their positions in the xy plane.

Next, the movable part 31 protrudes from the inside of the pipe 12 via the holes 122 (Step S103). In the first embodiment, the movable part 31 is lowered by pneumatic-driving. Then, the movable part 31 protrudes from the inside of the pipe 12 toward the protruding part 21 (the z-axis negative direction) via the holes 122. Then, the battery unit 10 is lifted by the movable part 31, and the pipe 12, and the protruding part 21 are brought to a state of being spaced apart from each other.

Next, the battery unit 10 is conveyed outside the case 20 (Step S104). In the state of the pipe 12 and the protruding part 21 being spaced apart from each other, the battery unit 10 is pushed or pulled in the conveyance direction (the y-axis direction). Then, the movable part 31, i.e., the roller, slides along the conveyance direction (the y-axis direction) on the protruding part 21, and the battery unit 10 is conveyed outside the case 20. For example, as shown in FIG. 6, the battery unit 10 is pulled out to a loading platform 40 and conveyed outside the case 20. An operator or a robot may push or pull the battery unit 10 in the conveyance direction (the y-axis direction). In addition, the battery unit 10 may be conveyed outside the case 20 by the self-propelled roller.

Next, the movable part 31 is housed inside the pipe 12 (Step S105). In the first embodiment, the movable part 31 is elevated by pneumatic-driving. Then, the movable part 31 is housed inside the pipe 12. Then, the pipe 12 is placed on the loading platform 40, for example, as shown in FIG. 6.

Finally, the rod member 30 is pulled out of the pipe 12 along the conveyance direction (the y-axis direction) (Step S106). At the time of extraction, the movable part 31 is in an elevated state (the z-axis positive direction), and is therefore housed in the pipe 12. The rod member 30 that has been pulled out may be used in replacement of another battery pack 11.

As described above, in the battery pack replacement system according to the present disclosure, by using the rod member 30 provided with an elevatably-movable part 31 in the stacking direction (the z-axis direction), the battery unit 10 can be easily conveyed into or out of the case 20 even in the case where the case 20 does not have much space for densely stacking the battery units 10.

It should be noted that the present disclosure is not limited to the above-described embodiment, and may be appropriately modified without departing from the purport.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack replacement system, comprising:
a battery unit including a battery pack and a pipe, a direction along one side of a bottom of the battery pack being a conveyance direction of the battery unit and the pipe being fixed along a lower surface or a side surface of the battery pack;
a case for stacking and housing the battery unit therein; and
a rod member that is configured to be inserted into the pipe along the conveyance direction of the battery unit and has a movable part configured to be elevatable in a stacking direction of the battery unit,
wherein
the battery unit is conveyed to the case along the conveyance direction of the battery unit, and is housed in the case by placing the pipe on an upper surface of a protruding part protruding inward from an inner wall of a side surface of the case,
the pipe includes holes that are formed in the surface thereof to be placed on the protruding part,
the rod member inserted into the pipe is configured to:
have the movable part protrude from inside the pipe through the holes to thereby bring the pipe and the protruding part to a state of being spaced apart from each other; and
house the movable part into the pipe to thereby place the pipe on the protruding part.

2. The battery pack replacement system according to claim 1, wherein the battery unit is conveyed into or out of the case by pushing or pulling the battery unit in the conveyance direction thereof under a state in which the pipe and the protruding part are spaced apart from each other, the movable part being configured to protrude from the pipe via the holes.

3. The battery pack replacement system according to claim 1, wherein the movable part is a roller.

4. The battery pack replacement system according to claim 3, wherein the movable part is configured to be elevatable by pneumatic-driving.

5. The battery pack replacement system according to claim 4, wherein a cross-sectional outer profile of the pipe is rectangular.
